(19) United States
(12) Patent Application Publication
(10) Pub. No.: US 2022/0176267 A1
(43) Pub. Date: Jun. 9, 2022

(54) MESH BAFFLE FOR WIPED FILM EVAPORATOR

(71) Applicants: Agustus Berman SHELANDER, Los Angeles, CA (US); Vanessa DE LA PUENTE, Joshua Tree, CA (US); Lola VARS, Los Angeles, CA (US)

(72) Inventors: Agustus Berman SHELANDER, Los Angeles, CA (US); Vanessa DE LA PUENTE, Joshua Tree, CA (US); Lola VARS, Los Angeles, CA (US)

(21) Appl. No.: 17/462,178

(22) Filed: Aug. 31, 2021

Related U.S. Application Data
(60) Provisional application No. 63/122,605, filed on Dec. 8, 2020.

(51) Int. Cl. B01D 1/22; B01D 5/00

(52) U.S. Cl. CPC B01D 1/225; B01D 5/006

(57) ABSTRACT

An improved thin film evaporator for evaporating a liquid solution. A housing contains a solution inlet for the solution to enter, a concentrate outlet for a concentrate to exit, and a residue outlet for a residue to exit the evaporator. An evaporation surface evaporates at least part of the solution to form a vapor when heated, and a condensation surface condenses the vapor when cooled. A wiper carrier holds wiper blades with a blade edge that is rotated by a rotator shaft, so the blade edges move across the evaporation surface. A mesh baffle is also part of the wiper carrier and is held between the evaporation and condensation surfaces as the wiper blades move therebetween, to assemble liquid droplets produced in the vapor and centrifuge them back towards the evaporation surface.

### CROSS-REFERENCE TO RELATED APPLICATIONS

This application claims the benefit of U.S. Provisional Application No. 63/122,605, filed Dec. 8, 2020, hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### Technical FIELD

The present invention relates generally to distillation using a thin film evaporator, and more particularly to such where wipers or rollers affixed to a carrier distribute the film about the inner surface of a cylindrical body.

### BACKGROUND ART

Thin Film Distillation, also referred to as Wiped Film Distillation, is carried out by heating a liquid solution and spreading it mechanically into a thin film on a hot surface until gaseous vapors evaporate from the liquid solution.

This is commonly done using a set of wipers rotating against the inside of a hot evaporation surface, typically cylindrical in shape, to help spread and maintain the liquid solution thereupon in a thin film. Subsequently, the vapors are recondensed on a condensation surface or surfaces, forming a condensate. The condensation surface or surfaces are commonly also contained within the volume of the evaporator.

Unfortunately, because of the proximity of the evaporation and condensation surfaces it is possible to contaminate the desired condensate with liquid droplets from the evaporation surfaces and/or to evaporate and to condense out heavier components than intended from the liquid solution.

To partially address such problems, sheet metal baffles or gauze mesh can be placed in the vapor path between the places of evaporation and condensation to reduce the collection of any undesired components.

U.S. Pat. No. 3,474,850 for a Liquid Film Evaporator by inventor Rolf Germerdonk is an example of this approach using a gauze in a cylindrical shaped evaporator (most common) as well as in a conical evaporator. Germerdonk also discusses yet earlier approaches using solid baffles.

Nonetheless, there remains a need for improved apparatus and methods to further reduce or eliminate collection of unintended components.

### BRIEF SUMMARY OF THE INVENTION

Accordingly, it is an object of the present invention to provide an improved thin film or wiped film evaporator.

Briefly, one preferred embodiment of the present invention is an improved thin film evaporator for evaporating a liquid solution. The evaporator is of the type having a housing containing other elements of the evaporator. These elements include a solution inlet for the liquid solution to enter, a concentrate outlet for a concentrate to exit, and a residue outlet for a residue to exit the evaporator. Further included is an evaporation surface wherein evaporation of at least part of the of the liquid solution can occur to form a vapor when the evaporation surface is heated. Also further included is a condensation surface wherein condensing of the vapor into the concentrate can occur when the condensation surface is cooled. And yet further included is a wiper carrier holding multiple wiper blades that each have a blade edge. The wiper carrier is rotated within the evaporator by a rotator shaft, so the blade edges move across the evaporation surface. The improvement in the present thin film evaporator is the use of a mesh baffle that is also connected to the wiper carrier, and that is kept between the evaporation surface and the condensation surface as the wiper blades move therebetween. This mesh baffle thereby assembles liquid droplets and centrifuges them back towards the evaporation surface.

Briefly, another preferred embodiment of the present invention is an improved thin film evaporation process for producing a condensate from a liquid solution. The process has the steps of wiping the liquid solution onto an evaporation surface, heating the evaporation surface, cooling a condensation surface, evaporating at least part of the liquid solution on the evaporation surface to form a vapor, conveying the vapor from the evaporation surface to the condensation surface, and condensing the vapor on the condensation surface to form a condensate. The improvement in the present thin film evaporation process is in the condensing. This includes capturing liquid droplets in the vapor in a mesh baffle kept between the evaporation surface and the condensation surface and directing those liquid droplets centrifugally back towards the evaporation surface. These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is an external side view of an evaporator in accord with the present invention;

FIG. 2 is a partial cut-away side view showing some of the major interior features of the evaporator in FIG. 1;

FIG. 3 is an alternate partial cut-away side view showing other features of the evaporator in FIGS. 1-2;

FIGS. 4a-b are cross-sectional views of the evaporator in FIGS. 1-3, wherein FIG. 4a is a top view of cross section A-A in FIG. 1 and FIG. 4b is a partial perspective view of cross section A-A;

FIG. 5 is perspective view of just the wiper carrier, with the shape characteristics of a section of the mesh baffle emphasized;

FIG. 6 is schematic cut-away side view of one set of material characteristics for the mesh baffle; and

FIG. 7 is a flow chart showing an improved thin film evaporation process in accord with the present invention.

In the various figures of the drawings, like references are used to denote like or similar elements or steps.

### DETAILED DESCRIPTION OF THE INVENTION

A preferred embodiment of the present invention is a mesh baffle for a wiped film evaporator, as illustrated in the various drawings herein, wherein embodiment(s) of the invention are depicted by the general reference character 10.

The present invention seeks to substantially reduce or eliminate the possibility of liquid contamination of a condensate, and to also enhance the purity of such condensate by adding a mesh baffle that functions in either or both of two manners.

Firstly, the mesh baffle can act in a filter-like manner to capture liquid droplets. A liquid solution is evaporated at an evaporation surface, creating a vapor that can contain still liquid droplets. If the vapor contains such droplets when it is later condensed at a condensation surface, the resulting condensate can be contaminated or of a lessor purity than desired. Capturing such droplets on and in the mesh baffle thus permits them to redirected (by centrifugal force) back toward the evaporation surface, rather than permitting them to reach the condensation surface.

Secondly, the mesh baffle can act in an intermediate condensation-evaporation surface like manner, in effect adding a secondary distillation process or “plate,” to create liquid droplets. The intermediate surface here is thus one and the same with intermediate condensation and intermediate evaporation surfaces. As the vapor passes through the mesh some may condense, this puts heat energy into the mesh and any liquid already there. This provides energy to evaporate some portion of the liquid on the mesh. That portion may continue onward into the mesh, to additional layers if present, or ultimately to the condensation surface. Alternately, the portion not evaporated, that is, the portion still liquid (as created liquid droplets), can be redirected (by centrifugal force) back towards the evaporation surface.

Action similar to this second manner of vapor condensing to liquid, some liquid evaporating, and some being returned back to the evaporation surface, albeit performed using different apparatus than the present invention is commonly be called “reflux” in traditional fractional distillation. The fraction of liquid that re-vaporizes vs being returned to the primary evaporator surface thus has not been quantified.

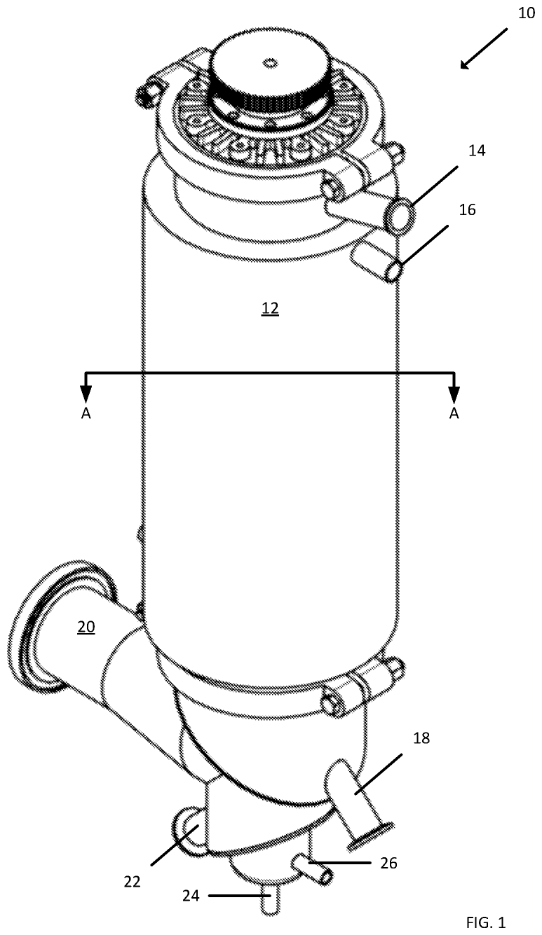

FIG. 1 is an external side view of an evaporator 10 in accord with the present invention. The evaporator 10 has a housing 12 to generally contain the elements of the evaporator 10. The housing 12 includes a solution inlet 14 for a liquid solution to enter the evaporator 10, a concentrate outlet 16 for a concentrate to exit the evaporator 10, and a residue outlet 18 for a residue to exit the evaporator 10. The housing 12 further includes a heating fluid inlet 20, a heating fluid outlet 22, a cooling fluid inlet 24, and a cooling fluid outlet 26.

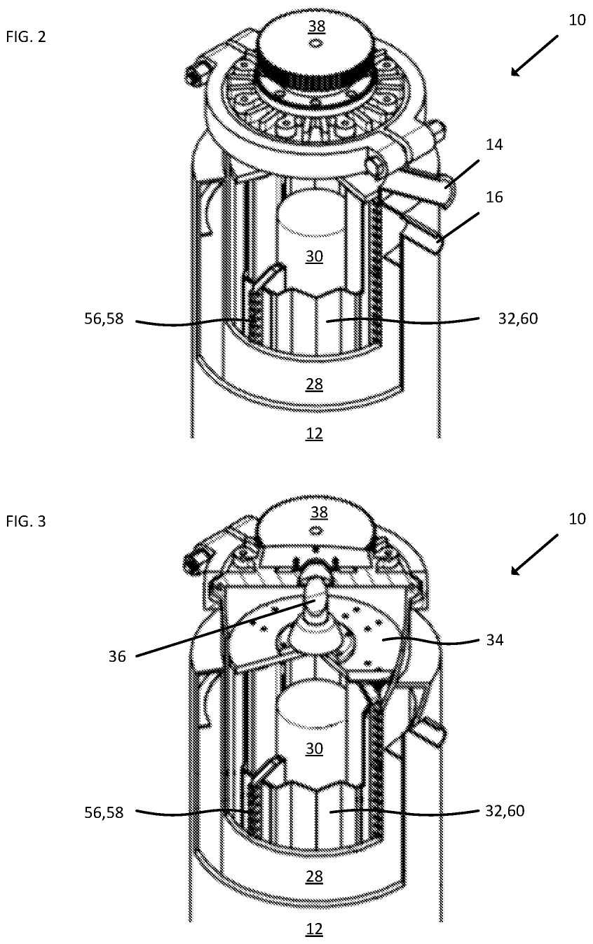

FIG. 2 is a partial cut-away side view showing some of the major interior features of the evaporator 10 in FIG. 1. In particular, these features include a heating wall 28, a cooling wall 30, and a wiper carrier 32.

FIG. 3 is an alternate partial cut-away side view showing other features of the evaporator 10 in FIGS. 1-2. These other features include a top plate 34 of the wiper carrier 32 that is attached to a rotator shaft 36, which in turn is attached to a drive mechanism 38 for a means (not shown) that is external to the evaporator 10 to rotatably move the wiper carrier 32.

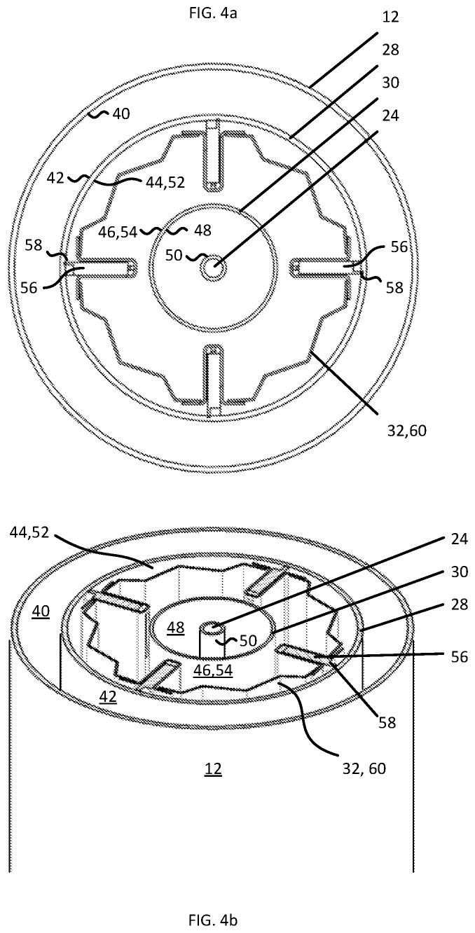

FIGS. 4a-b are cross-sectional views of the evaporator 10 in FIGS. 1-3, wherein FIG. 4a is a top view of cross section A-A in FIG. 1 and FIG. 4b is a partial perspective view of cross section A-A. Again, the housing 12, the cooling fluid inlet 24, the heating wall 28, the cooling wall 30, and the wiper carrier 32 are shown, but with many added details.

The housing 12 has an interior face 40, the heating wall 28 has an exterior face 42 and an interior face 44, the cooling wall 30 has an exterior face 46 and an interior face 48, and the cooling fluid inlet 24 has an exterior face 50. The region between the interior face 40 of the housing 12 and the exterior face 42 of the heating wall 28 forms a heating jacket wherein the interior face 44 of the heating wall 28 becomes an evaporation surface 52 when a heated fluid (e.g., oil) is circulated between the heating fluid inlet 20 and the heating fluid outlet 22 (FIG. 1). The region between the interior face 48 of the cooling wall 30 and the exterior face 50 of the cooling fluid inlet 24 forms a cooling jacket wherein the exterior face 46 of the cooling wall 30 becomes a condensation surface 54 when a cooled fluid (e.g., water) is circulated between the cooling fluid inlet 24 and the cooling fluid outlet 26 (FIG. 1).

Turning now to the wiper carrier 32, it is located between the evaporation surface 52 and the condensation surface 54, as shown and as is characteristic for thin film distillation (aka, wiped film distillation). The wiper carrier 32 carries wiper blades 56 each having a blade edge 58, to wipe the liquid solution onto the evaporation surface 52, where portions evaporate, become vapor, and are able to travel toward the condensation surface 54.

As described in the Background Art section, however, a serious problem in this art is that the vapor may contain liquid droplets. To address this in the inventive evaporator 10 the wiper carrier 32 further has and carries a novel mesh baffle 60. The mesh baffle 60 may employ either or both of shape and/or material characteristics to suppress liquid droplets from reaching the condensation surface 54 and contaminating the concentrate being produced.

FIG. 5 is perspective view of just the wiper carrier 32, with the shape characteristics of a section of the mesh baffle 60 emphasized. The mesh baffle 60 may be formed to increase its surface area (i.e., beyond that of a simple geometric cylinder), or formed with baffle portions 62 bent or angled or pleated to both increase surface area and to maximize centrifugal force on liquid droplets to propel them back toward and onto the evaporation surface 52 and away from the condensation surface 54.

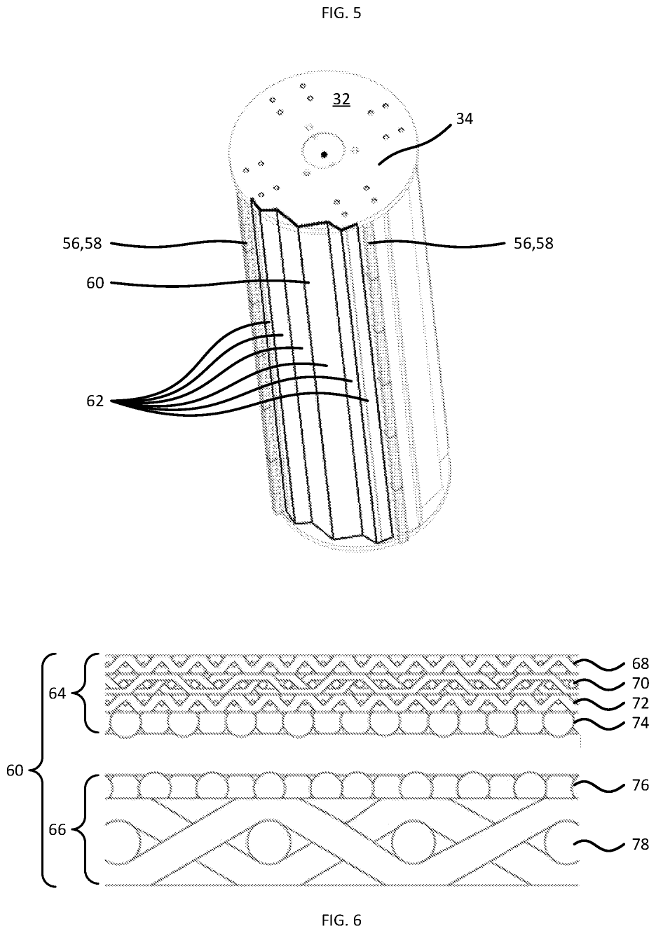

FIG. 6 is a schematic cut-away side view of one set of material characteristics for the mesh baffle 60. The mesh baffle 60 may be multilayered, as shown here with two spaced apart main layers (layer 64 and layer 66). In layer 64 there is a sub-layer 68 that has a zero (0) degree fine mesh, followed by a sub-layer 70 that has a 90 degree fine mesh, followed by a sub-layer 72 that also has a zero (0) degree fine mesh (shown here as the same as sub-layer 68 but that is not a requirement), followed by a sub-layer 74 that has a zero (0) degree coarse mesh. In layer 66 there is a sub-layer 76 that has a zero (0) degree coarse mesh (shown here as the same as sub-layer 74 but that is not a requirement), followed by a sub-layer 78 that has a 90 degree very coarse mesh. In the inventor's currently preferred embodiment of the evaporator 10, the mesh baffle 60 is a pressed and sintered together metallic fabric, which particularly helps make the mesh baffle 60 rigid and self-supporting. Concurrently, this also make the wiper carrier 32 more robust and able to more securely carry the wiper blades 56.

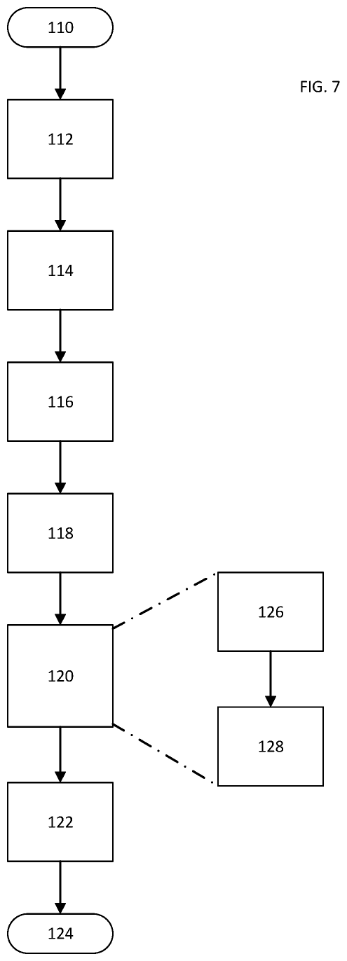

FIG. 7 is a flow chart showing an improved thin film evaporation process 100 in accord with the present invention. The process 100 includes starting 110, wiping 112 the liquid solution onto an evaporation surface 52, heating 114 the evaporation surface 52, cooling 116 a condensation surface 54, evaporating 118 at least part of the liquid solution on the evaporation surface 52 to form a vapor, conveying 120 the vapor from the evaporation surface 52 to the condensation surface 54, condensing 122 the vapor on the condensation surface 54 to form a condensate, and stopping 124.

As described in the Background Art section, and already discussed with respect to in the evaporator 10, a serious problem in this art is that the vapor may contain liquid droplets. To address this the step of conveying 120 includes capturing 126 liquid droplets in the vapor in a mesh baffle 60 held in a spaced relation between the evaporation surface 52 and the condensation surface 54, and further centrifugally directing 128 those liquid droplets back towards the evaporation surface 52.

Accordingly, this invention improves on the existing methods by combining the properties of rigid sheet metal baffles and fabric or gauze mesh by instead using a mesh baffle, and one which may particularly be of a sintered metal fabric. These features allow for a rigid structure with a very fine pore size, a large open area, and a large total surface area in a manner where all desirable properties are achieved simultaneously.

While various embodiments have been described above, it should be understood that they have been presented by way of example only, and that the breadth and scope of the invention should not be limited by any of the above described exemplary embodiments but should instead be defined only in accordance with the following claims and their equivalents.

What is claimed is:

1. An improved thin film evaporator for evaporating a liquid solution, wherein the evaporator is of the type having a housing containing:
a solution inlet for the liquid solution to enter the evaporator,
a concentrate outlet for a concentrate to exit the evaporator,
an evaporation surface wherein evaporation of at least part of the liquid solution can occur to form a vapor when the evaporation surface is heated,
a condensation surface wherein condensing of the vapor into the concentrate can occur when the condensation surface is cooled, and
a wiper carrier holding a plurality of wiper blades each having a blade edge, wherein the wiper carrier is rotatably driven within the evaporator by a rotator shaft such that the blade edges are movable in close proximity to the evaporation surface, the improvement comprising:
a mesh baffle also connected to the wiper carrier and held in a spaced relation between the evaporation surface and the condensation surface as the wiper blades move therebetween, said mesh baffle to thereby assemble liquid droplets produced in the vapor and centrifuge them back towards the evaporation surface.

2. The evaporator of claim 1, wherein said mesh baffle is a metallic fabric.

3. The evaporator of claim 1, wherein said mesh baffle has at least two layers that are pressed together.

4. The evaporator of claim 1, wherein said mesh baffle has at least two layers that are sintered together.

5. The evaporator of claim 1, wherein said mesh baffle is formed with a surface area greater than a geometrical cylinder.

6. The evaporator of claim 5, wherein said mesh baffle is pleated.

7. The evaporator of claim 1, wherein said mesh baffle includes bent or angled baffle portions to increase centrifugal force applied on said liquid droplets.

8. An improved thin film evaporation process for producing a condensate from a liquid solution, the process having the steps of:
(a) wiping the liquid solution onto an evaporation surface,
(b) heating the evaporation surface,
(c) cooling a condensation surface,
(d) evaporating at least part of the liquid solution on the evaporation surface to form a vapor,
(e) conveying the vapor from the evaporation surface to the condensation surface, and
(f) condensing the vapor on the condensation surface to form a condensate,
the improvement comprising, in the step (e):
(1) capturing liquid droplets in the vapor in a mesh baffle held in a spaced relation between the evaporation surface and the condensation surface, and
(2) centrifugally directing said liquid droplets back towards the evaporation surface.

9. The process of claim 8, wherein said mesh baffle has at least two layers wherein step (e)(1) is performed partially in each said layer.

10. The process of claim 8, wherein said mesh baffle has a surface area greater than a geometrical cylinder to facilitate said step (e)(1).

11. The process of claim 10, wherein said surface area of said mesh baffle is pleated.

12. The process of claim 10, wherein said mesh baffle is bent or angled to have a surface area greater than a geometrical cylinder to facilitate said step (e)(1).

13. The process of claim 8, wherein said mesh baffle is bent or angled to increase centrifugal force applied on said liquid droplets to facilitate said step (e)(2).

14. The process of claim 13, wherein said mesh baffle is pleated to increase centrifugal force applied on said liquid droplets to facilitate said step (e)(2).
